(19) United States
(12) Patent Application Publication
(10) Pub. No.: US 2008/0209037 A1
(43) Pub. Date: Aug. 28, 2008

(54) System and method for enforcing in real time corporate business rules on web users

(76) Inventors: Dror Zernik, Haifa (IL); Itai Nahshon, Haifa (IL); Shachar Nanes, Jerusalem (IL)

Correspondence Address: Kevin D. McCarthy;Roach Brown McCarthy & Gruber, P.C., 1620 Liberty Building, 420 Main Street, Buffalo, NY, 14202, US

(21) Appl. No.: 11/702,374

(22) Filed: Feb. 5, 2007

(51) Int. Cl. G06F 15/173

(52) U.S. Cl. 709/225

(57) ABSTRACT

The invention relates to a method for enforcing corporate rules in real time at a user end within a business web application operated from the corporate site server, wherein said web application conveys to a user browser a form to fill in, and wherein said form includes one or more pages, each page comprises one or more fields for receiving user entries, the method comprising: (a) providing a monitoring server at the corporate side; (b) providing a corporate rule base accessible by said monitoring server, wherein each rule within the base comprises at least: (i) a scenario definition, each scenario definition comprises at least one condition depending on a user behavior within a form; and (ii) a predefined action to be activated in real-time when said scenario definition is met; (c) upon accessing the corporate server to receive a form, sending to a user terminal a first page of the form, including an RT monitoring program for monitoring the meeting of one or more rule scenarios at the user terminal and at least a reference to said monitoring server; (d) upon receipt of the form at the user side, activating said RT monitoring program at the user terminal including said reference, thereby to access said monitoring server; (e) upon accessing said monitoring server, sending by the monitoring server to said user terminal one or more rules from said rule base; (f) monitoring by said RT program the user behavior within at least one of the form pages; and (g) upon detection that a rule scenario is met, immediately activating the action which corresponds to said rule scenario.

### FIELD OF THE INVENTION

The present invention relates to the field of self-service applications; i.e., corporate applications which use Internet-based interfaces, to support a variety of business processes. In such an environment, the user that interacts with the system is either an end-customer or a company agent, working from home, or on the road, trying to access the company's Internet site, which, in the context of the present invention, is typically the self-service part of the Customer Relation Management (CRM). The present invention proposes a system and method for ensuring that business rules that are applicable in internal environments, such as in-house CRM, or in a call center, can be automatically enforced also in the web environment. In a similar manner, the present invention enables help or tutoring tools etc., which are provided to in-house agents, to be easily applied to and enforced upon web-users.

### BACKGROUND OF THE INVENTION

In today's business environment many companies have multiple contact points with their customers, or even with their agents, and for each such environment a different technology is used. Internally, employees use Enterprise Resource Planning (ERP) applications, Customer Relation Management (CRM) applications, and Back-Office applications, in order to perform their business processes.

Often, however, additional logic, which is generated and enforced by external tools, is applied. This logic is designed to enforce business rules across multiple applications (such as CRM or ERP) or even within a single application, spanning multiple stages. These rules are designed for, or allow for, assisting employees in order to improve their efficiency and effectiveness, and in order to ensure compliance with frequently changing business needs that are generally transformed into rules. An exemplary usage of such rules is the providing of the “best offer”; i.e., the product that would be best sold. These rules are typically introduced by independent tools, such as marketing tools (e.g. Campaign Management (CM)), or by Business Process Management (BPM) tools.

While all of these tools are applied internally, there is a growing need to apply a closely related version of these rules and their business applications over the Web to customers or field-agents using computers, PDAs or even over customized cellular phone.

There is a need to ensure that these contact points, often referred to as Points of Sale or Points of Service (POS), abide by the same business rules and offer the same assistance to the user. Further, a version of the rules which relates to marketing, such as the rules relating to “best-offer” and for customer retention, needs to be applied also for end-customers of the organization over the Web.

The Web as an additional channel introduces several challenges which have not been met so far:
1. Agents and customers are remote—and there is no tight control over their operation environment. It is practically impossible to control installations or to enforce an installation of corporate software on the end user devices.
2. Agents who are sometimes in house and sometimes in the field expect a similar support and business guidance in both work environments.
3. The organization is unlikely to maintain multiple coherent and updated repositories of business rules. It is, of course, desirable to have only one rule base for all the corporate interfaces and thus avoid the need to update multiple environments for a single updated rule.
4. In web environments, state information can be saved only in the browser. The server is stateless. Rules, however, may require complex state analysis that has to be performed on both the server and the browser. Further, rules may involve information which comes from both the browser environment (for example, input typed by the customer within the currently displayed screen) and from the server environment for example, information from corporate database).

For example, an insurance company offers a flood insurance policy to all of its U.S. customers. The policy can be offered to customers via both the call centers by agents who operate ERP and CRM applications, and via the Internet, to the customers, or prospective customers. When the weather forecast shows that a hurricane is approaching the State of Louisiana and it is expected to arrive within two days, the company may decide to cease offering flood insurance policies to New Orleans citizens and surrounding areas until after the hurricane passes. A suitable rule is formed and imposed within the call center, and guides the agents to prevent offering flood insurance policies to New Orleans and surrounding areas' customers. However, imposing the same rules over the Web is challenging. The same company, which also operates a website over the Internet, does not have a mechanism for automatically enforcing this rule. The rule can be programmed into the Web page, which implies that when the complete form is submitted, the request will be rejected. Just before offering the quote the system may detect that a customer who asks for a flood insurance quote via the Internet actually resides in New Orleans area. Normally, introducing a suitable software mechanism that will check the residency and prevent acceptance of the policy if this residency condition exists takes weeks, if not more. Furthermore, even if this software change is performed at the corporate ERP and CRM software, the manner that the Internet typically operates; i.e., as a stateless server, has so far prevented checking the user typed residency in real-time. Therefore, the rejection of the policy upon determination that the customer lives in New Orleans area occurs in the prior art only very late in the process, when the customer has already filled in many forms. More particularly, the enforcement of such new corporate rule immediately on those who use the corporate Internet site is impossible according to the prior art. This is only one typical example. There are various other cases in business applications where a real time monitoring of the end user inputs is necessary over the Web in order to immediately take a corresponding action.

The present invention provides a solution to such a problem, and it enables enforcing any new rule that is applied at the internal system also on users who access the system over the Internet.

It is therefore an object of the present invention to introduce a system that enables the applying and enforcing business rules to processes performed over the Web.

It is further an object of the present invention to prevent the need to program the rules into the Web application.

It is an additional object of the present invention to allow for rules to span across multiple stages of a business process.

It is an additional object of the present invention to allow for the Web server to remain stateless, and for the application to remain practically untouched.

It is a further object of the present invention to allow for importing rules that are deployed in non-Web-based applications to the Web-application.

It is a further object of the present invention to support the display and guidance through the carrying out of a business process, where said display can be either a pop-up, or a dialogue box within the core Web process.

It is an important object of the present invention to enable building said new and frequently changing rules on top of existing Web applications as an independent layer, without having to change the application business logic.

It is still another object of the present invention to detect in real time a state in a business process at an end user terminal communicating over the Web, and to provide the user guidance for action based on this state.

It is still another object of the present invention to respond to said detection of predefined states in a business process at the end user by the activation of actions that are programs, or by additional Web applications.

Other objects and advantages of the present invention will become apparent as the description proceeds.

### BRIEF DESCRIPTION OF THE DRAWINGS

In the drawings:

FIG. 1 is a block diagram illustrating the structure of a typical prior art business system;

FIG. 2 is a block diagram illustrating the structure of a business system which includes a monitoring server for enforcing the corporate rules on web users in real time; and

FIG. 3 is an exemplary sequence diagram illustrating the operation of the system according to the invention.

### SUMMARY OF THE INVENTION

The invention relates to a method for enforcing corporate rules in real time at a user end within a business web application operated from the corporate site server, wherein said web application conveys to a user browser a form to fill in, and wherein said form includes one or more pages, each page comprises one or more fields for receiving user entries, the method comprising: (a) providing a monitoring server at the corporate side; (b) providing a corporate rule base accessible by said monitoring server, wherein each rule within the base comprises at least: (i) a scenario definition, each scenario definition comprises at least one condition depending on a user behavior within a form; and (ii) a predefined action to be activated in real-time when said scenario definition is met; (c) upon accessing the corporate server to receive a form, sending to a user terminal a first page of the form, including an RT monitoring program for monitoring the meeting of one or more rule scenarios at the user terminal and at least a reference to said monitoring server; (d) upon receipt of the form at the user side, activating said RT monitoring program at the user terminal including said reference, thereby to access said monitoring server; (e) upon accessing said monitoring server, sending by the monitoring server to said user terminal one or more rules from said rule base; (f) monitoring by said RT program the user behavior within at least one of the form pages; and (g) upon detection that a rule scenario is met, immediately activating the action which corresponds to said rule scenario.

In one variation of the invention, said user behavior is at least one predefined user entry within at least one field within a form page.

In another variation of the invention, said user behavior is a predefined navigation sequence into at least one predefined form page.

In still another variation, the scenario condition further includes specific data entries from the corporate database into form pages in response to one or more user entries.

Preferably, said one or more rules are sent from the monitoring server to the user terminal within a cookie.

Alternatively, one or more rules that are sent from the monitoring server to the user terminal are sent as an XML file.

Alternatively, said RT program is a Javascript, Ajax or ActiveX program.

In an embodiment of the invention, wherein the form comprises more than one page, and wherein with each access of the client to receive a form page, a copy of the RT program is also provided and activated at the client side.

In an embodiment of the invention, said action involves an access to the monitoring server to receive an additional program which is activated at the client terminal.

In an embodiment of the invention, the action includes initiation of at least one of the following: (a) displaying at the client terminal a predefined message; (b) preventing the insertion of specific data to a specific field of the form; (c) preventing the possibility of submitting the form; and (d) providing guidance to the user for an allowed field entry.

In an embodiment of the invention, the business application is a CRM or ERP application.

In an embodiment of the invention, the communication between the business application, the monitoring server and the user browser is stateless.

In an embodiment of the invention, said rule base is a common corporate rule base wherein a portion of the rules within said rule base are used for enforcement only over in-house users, another portion is used for enforcement over only web users, and at least a portion of the rules is used for enforcement over both in-house users and web users.

In an embodiment of the invention, a rule definition further comprises at least one milestone, in which a communication is made to the corporate server for receiving a corresponding data in response to reaching said milestone.

### DETAILED DESCRIPTION OF PREFERRED EMBODIMENTS

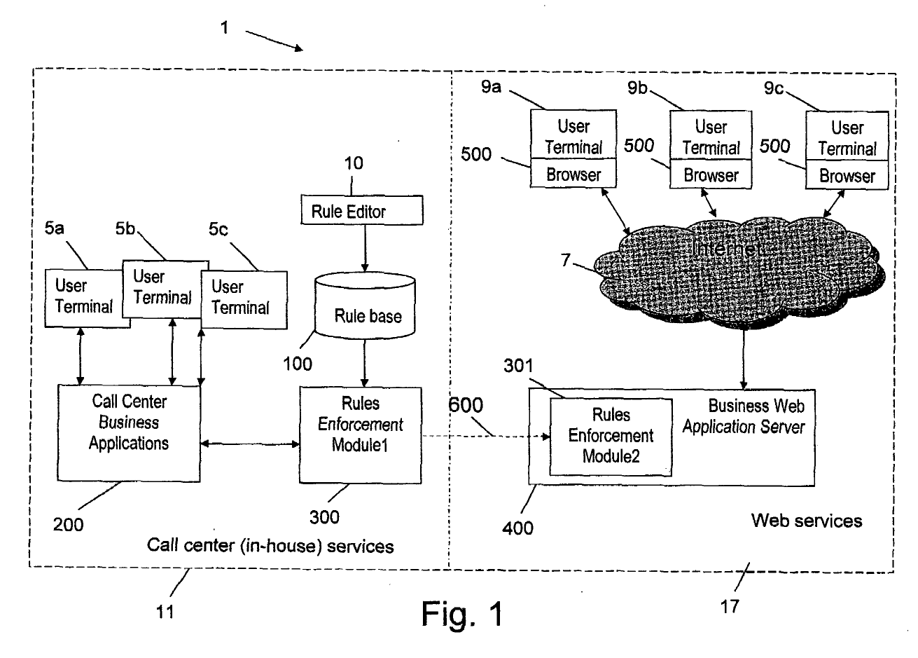

FIG. 1 shows a typical prior art business system 1. Typically, the system provides in-house services 11, and web services 17. The system comprises one or more in-house business applications, such as ERP and CRM 200, which are operated within the corporate and are used by in-house agents, such as those working in a call center. Typically, these applications display to the agent plurality of forms which include plurality of fields, wherein some of field entries are extracted from the corporate database (not shown) and some are inserted on-line by the agent during his interaction with the customer.

In order to enforce the corporate policy over all the application instances at in-house user terminals 5a, 5b, 5c . . . , (in this case particularly the in-house corporate agents, but also other workers), a rule base 100 is provided which stores the various corporate rules. It should be noted that the term “rule” used throughout this application relates to any type of item relating to the corporate policy that is either applied (i.e., enforced) or brought to the knowledge of the user. Said rules may be, for example, some new regulations relevant to several specific field entries (for example the city residence of the customer, or the type of insurance requested, which are relevant in the example discussed above in the “Background of the Invention”). Other rules may reflect the corporate new policies regarding various types of clients (for example: discount to customers over 50 years old); others may reflect various offers to specific types of customers (for example, customers who are at risk of leaving the corporate); and other rules may reflect a state within the form-filling process, and an action that need to be performed if this state is met. Such rules, in their nature, are frequently changing, are typically updated by a business or a marketing manager using a rule editor 10, and are very desirable to be enforced on all the application users. For enforcing the rules, the system also comprises a rules enforcement module1 300 which propagates and applies the rules over all the in-house application users.

Typically, the corporate also operates a corporate web site, from which multiple customers by means of their user terminals 9a, 9b, 9c, etc. . . . can access through the Internet 7 and perform various operations and business activities (for example, applying for an insurance policy) using a browser 500 which interacts with a business web application 400. In some cases, the web applications are also used by the corporate workers for performing various operations. As said, it is generally desirable that the web applications will be in full compliance with the internal business applications. In other words, it is desirable to enforce same rules 100 also on the web applications. However, the fact that the remote access to the web site is performed by means of a browser, the fact that the web site server is stateless, and the fact that no software can be installed at the user computer, introduces a significant burden to the enforcement of the corporate rules 100 on users who access the applications 400 via the web site. The introduction of each new rule, even within the in-house applications 200, typically requires a programming action, which typically takes several weeks until it can be introduced (as it requires design, development testing, debugging, etc.). Some prior art systems allow for in-house rule enforcement (by means of rule enforcement module1 300) that does not require programming, and which is applied on top of the business applications 200. The prior art systems also include off-line rules enforcement module2 301 which is typically in communication with said rules enforcement module1 300. However, rules enforcement module2 301 does not allow enforcement of the rules in real time (i.e., immediately upon user entries to specific fields within the forms) over web clients who operate user terminals 9a, 9b, 9c, and which use a browser 500 for communication with web business application server 400. In particular, these prior-art systems refer mostly to the in-house call-center, where real-time monitoring can take place, and avoid real-time enforcement of these rules over the web. Therefore, in the prior art systems the monitoring over web client entries into a form can be performed only after the form is fully filled in by the user and submitted to the web business application server 400. In other words, the prior art does not provide mechanism to support frequently changing rules with respect to web users who access the corporate web applications via the Internet 7 using web browsers 500. As a result, only a small portion of the rules 100 are typically enforced on web users interacting with business applications, and even then, those rules are not enforced in real time with respect to the user typing within the form fields. Further, these rules are typically ‘hard-coded’, that is, they cannot be provided as an independent layer which can be separated from the Internet contents. This hard coding is reflected in FIG. 1 by the dashed arrow 600, where rules must be manually translated to the Web environment.

According to the present invention, the rules enforcement is performed by monitoring in real time the activity of the web users during their interactions with the web site. During said monitoring, when a specific, predefined scenario condition is met, a specific action is performed by the browser. In the typical scenario the user receives one or more form pages. Each form page has one or more fields to fill in, and others which reflect data from the corporate database. The scenario condition for enforcing a rule is essentially an event where a field value, or a sequence of several field values that are filled by the user or by the corporate server meet a specific predefined condition. Examples for a condition may be:
1. User of age under 21 and living in the state of California;
2. User living in New Orleans region in the state of Louisiana and applying for a flood insurance;
3. User above the age of 25 and having one or more children;
4. User has jumped to screen number 5 in the sequence, and has also filled a “other” value in a previous selection menu.

All said scenario conditions are determined from the combinations of user entries and corporate database or services, within one or more of form fields which may span several pages. Some of these pages have been retrieved by a separate access to the web server while others are monitored within the browser.

In order to respond in real time, monitoring of the rules is carried out according to the present invention also at the user (browser) side. This monitoring at the browser side allows the monitoring of the user actions and responding immediately or, when necessary, further consulting with the corporate server for obtaining additional relevant information necessary to make a real-time decision.

The actions that may be taken following the meeting of a scenario condition are, for example:
1. Displaying to the user a predefined message corresponding for each condition; and/or
2. Preventing the user from entering specific data to a specific predefined field of a form; or
3. Preventing the user from submitting the form; or
4. Guiding the user to a more appropriate action, through a sequence of one or more display hints; or
5. Offering the user an alternative matching opportunity or product.

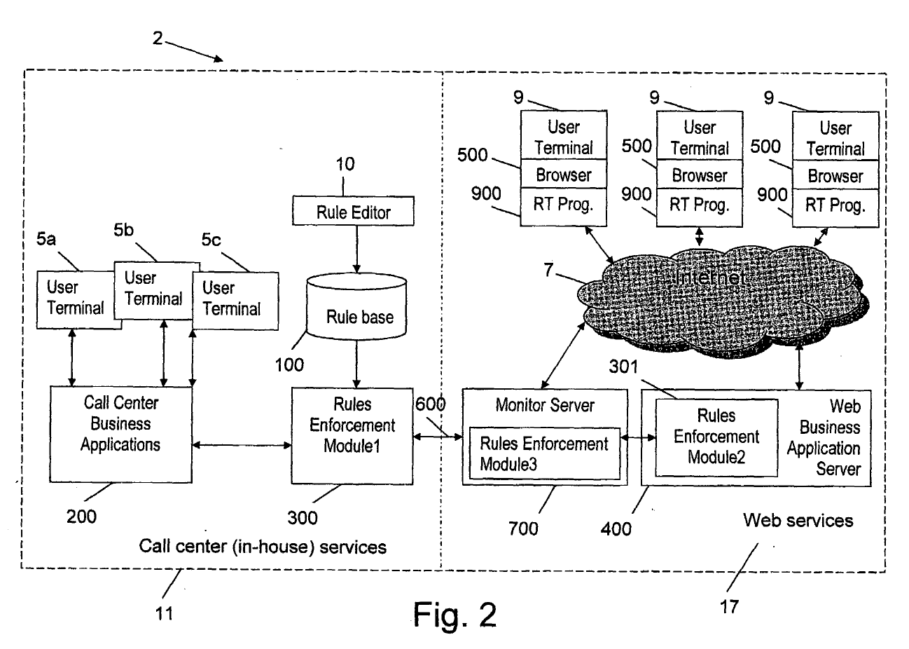

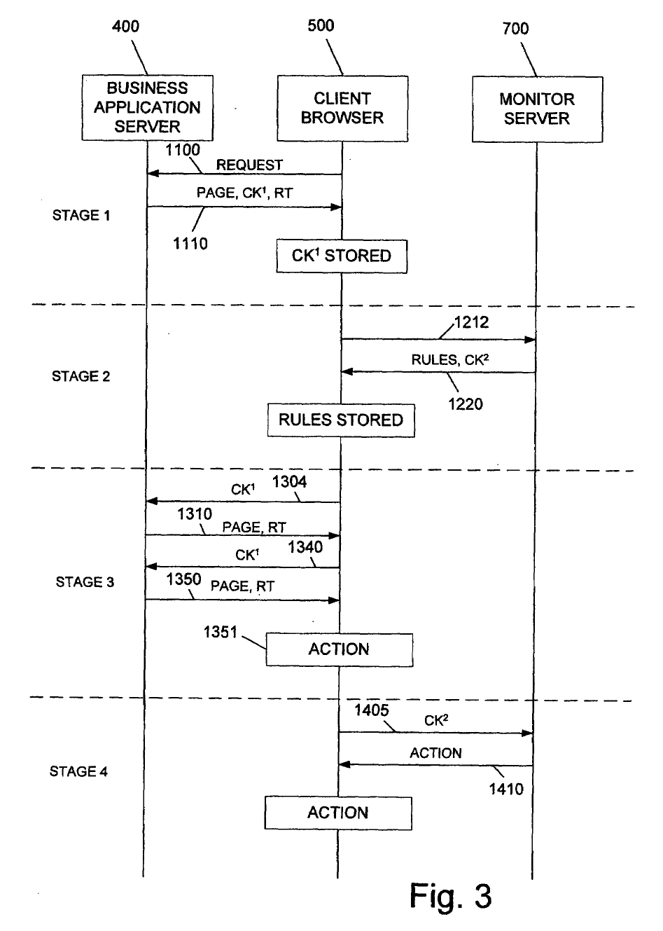

FIG. 2 shows a general structure of a system 2 for rule enforcement for web users of a business application according to one possible embodiment of the present invention. As in the prior art system of FIG. 1, the system comprises an in-house applications server 200, rule base 100 which is updated by rules editor 10, and internal rule-enforcement-module1 300. The system further comprises the corporate web services site 17, which in turn comprises a web business application server 400, and monitor server 700. The web application server 400 is essentially the same web business application server 400 of the prior art (see FIG. 1) operating under HTTP or HTTPS protocols, and running the corporate website applications. As before, web business application server 400 also comprises off-line rules enforcement module2 301. According to the present invention, the system further comprises a monitor server 700, which operates in communication with the rule base 100 in a manner as is described hereinafter with reference to FIG. 3.

The system also includes an additional RT program 900, which makes the browser 500 interact also with the monitor server 700. This RT program 900 forms the core of the real-time monitoring at the browser side.

Using this configuration, the rule enforcement module3 can automatically be updated from the rule base 100, and further, it can automatically update the rules used by the RT Program 900.

FIG. 3 details an exemplary sequence of interactions over the web between a user (client) browser 500 a web business application server 400, and monitoring server 700 according to a possible embodiment of the present invention. Web business applications server 400 and client browsers 500 (used by one of the users using user terminals 9a, 9b and 9c of FIG. 2) communicate in a standard HTTP or HTTPS protocols, and in a standard Internet environment. Such standard protocols operate in a HTTP_Request and HTTP_Reply manner, wherein the user terminal 9 accesses the web server 400 using his browser 500 and submitting HTTP_Request, and the web server 400 replies with a web page or pages (i.e., HTTP_Reply), while not maintaining a session status within the server 400. Any data relating to the session, or session ID, is maintained, as an example, within a cookie which is essentially a token which is provided to the user's browser, and is used by the browser in its next re-accessing to the web server 400 during the session. The cookie may be updated following any re-access to the web server 400 during the session, or by the browser 500.

According to the present invention, and with reference to FIG. 3, the user who uses browser 500 at user terminal 9a, 9b, or 9c (FIG. 2) requests a sequence of one or more pages from the HTTP applications Server 400. The first stage (Stage 1) begins with browser 500 accessing the Unique Resource Locator (URL) of a selected page on the server, which involves submitting a request 1100. The server 400 responds by transmitting 1110 a corresponding page to browser 500. Typically, during this first server transmission of the session, a cookie CK¹ is also transmitted along with the page. As is conventional, cookie CK¹ is used by both parties (i.e., the user browser 500 and the server 400) as a token to maintain continuity during the session, and to compensate for the fact that the server 400 operates as a stateless machine. In commercial applications the user is typically requested to identify oneself by logging in, and the user may further be requested to submit confidential information (such as password). By server 400 generating a unique cookie which cannot be forged, and which typically also contains a unique timer and communication identifiers, the server 400 guarantees that unauthorized requests will be denied service. This is a standard prior art manner of HTTP and HTTPS communication.

According to the present invention, in addition to the cookie CK¹, the server 400 also transmits a special program RT 900, for example a JavaScript program. The RT program 900 is embedded by the operator of Server 400 in every page which includes fields that are relevant to a scenario (conditions or actions) of a rule that needs enforcement. The RT program 900 monitors at the browser the form pages for data received from the server 400 and entries of the user in predefined fields within the form pages, as defined in the corresponding rule. Pages that have no relevancy to any of the enforced rules (from rule base 100 of FIG. 2), such as introductory pages, for example, may not include the RT program 900. If, however, a scenario or a business rule from said rule base 100 is designed to detect that the user now visits the introduction page, after visiting a specific earlier page P, both the introduction page and the specific page P need to include the RT monitoring program 900.

The RT program 900, when activated within the browser 500 for the first time, issues a new request 1212, this time to monitor server 700. The request 1212 to the monitor server 700 may contain the cookie CK¹, but this is not mandatory, since as a result of said latter request 1212, the monitoring server 700 responds by transmitting 1220 to the browser 500 an additional data, possibly in a cookie CK². In addition, the monitoring server 700 response 1220 contains a set of one or more rules from base 100 (Rule1, Rule2, Rule3, etc. . . . ) for the RT program to use. This is a converted section of the original rules. The set of rules may be contained in the cookie CK² itself or may be transmitted separately as an XML file. Typically, each rule contains:
1. Scenario definition: comprising at least one condition (or milestone) which needs to be monitored at the client side; i.e., by the browser 500 using RT program 900. A milestone may be, for example, a specific predefined value for a user entry to a predefined field or a specific value sequence for fields that may span more than one page; and
2. Predefined Action—when a predefined Scenario is reached, the Action defines what action to take, for example, what information to display to the user as an additional layer within the various pages in use, or whether to communicate the current state to the monitoring server 700.

The rules that are transmitted to the browser contain at least the portion of the rules that require real-time response. For example, during an application to flood insurance in the first example above, an immediate response to an entry of the name “Louisiana” in the address field should be generated. This portion of the rule has to be transmitted to the browser.

The rules that have to be enforced, as conveyed in transmission 1220 (stage 2) from the monitoring server 700, (either within or separate from CK²) are monitored at the user end, that is on the browser 500, and are used by the RT program 900 for rule enforcement. Thereafter, the cookie CK² preserves state information as monitored by the RT program 900. In Stage 3 the business process continues, and more pages and forms are being requested and retrieved.

In Stage 3 the user, by means of browser 500, continues the session by getting new form pages (HTTP requests 1304 and 1340, and HTTP replies 1310 and 1350). If any of these form pages contains information required for evaluating the scenario, then a copy of an RT program 900 is included in the page (for example, as in transmission 1350). When the RT program 900 is executed in a monitored page, using the rules that are saved in CK² (which as said is maintained at the client side), the RT program 900 collects and updates the monitored information into cookie CK².

Upon meeting a scenario condition the matching action (one or more) is performed by the RT program 900. The action carried out by the RT program either displays 1351 corresponding additional information to the user preferably using an additional HTML layer, or other Ajax capabilities, or as shown in stage 4, it communicates 1405 its state stored within cookie CK² to the monitoring server 700. The monitoring server 700, given the full state information as contained in CK², analyzes the state information, checks additional rules that require corporate resources, and thus may access corporate databases and marketing resources, and if necessary by the rule actions of the monitoring server 700 rules, issues more actions and/or corresponding display instructions to the RT program 500, which in turn will display 1410 the same to the user.

For example, the RT program 900, upon verifying that a scenario is met, may pop up a prompt, or a display message which guides the user, or it may provide the user specific offers which meet the organization ‘best offer’ criteria as evaluated at the monitoring server 700 using both client side (browser 500) information as well as global server side view of the organization and its tools.

The description of FIG. 3 is only one exemplary implementation. There are several other techniques that can be used instead. For example, instead of a JavaScript program, the entire in-browser monitor can be implemented as an Ajax application, or with other common browser-supported technologies such as Flash or ActiveX. Accordingly, also the delivery of rules can be implemented in other ways, such as an XML file, interacting with an Ajax program, or any other file structure that is acceptable by the browser side. It is important to note that the description FIG. 3 is a possible, preferred embodiment, but it is just an example, which does not have to be implemented as described in this example.

The invention enables meeting in real-time rules that can be evaluated at the browser side, as well as rules which require real-time information collection at the browser side and real time consulting with decision engines and corporate resources and databases at the server side.

### EXAMPLE 1

Let one assume that the corporate is an insurance company. The company offers home insurance throughout the U.S.A. via the Internet and its call centers. At some time, the weather forecast indicates that a hurricane is expected in New Orleans area within 48 hours. The corporate wishes to prevent offering home insurance to residents of the New Orleans area through all of its channels, call center agents, and customers accessing via the Internet. According to the present invention, using the rule editor 10, a business-oriented manager introduces a new rule Rule in an appropriate format into the rule base 100. Said rule Rule 701 is designed to ensure that when the relevant user fills in the insurance forms, and meets the scenario in which the user is in a process of applying for a home insurance, and the home is located within the area of New Orleans (this can be determined, for example, from the insurance type field home followed by the city field New Orleans, or alternatively by the zip code field 70XXX), an action is activated by which a message is displayed to the user notifying him that the insurance for residents of New Orleans is temporarily unavailable. Based on this rule, the process will proceed as follows. Said Rule 701 is stored in rule base 100. It is then converted into a form that can be split between the monitoring server 700 and the browser 500. Later on, when the user accesses the company web site 400, the browser 500 will receive a first home page and CK¹ (standard, prior art process). When he continues by clicking on a button within the corporate home page stating “Applying for Home Insurance”, a request is sent to server 400 together with CK¹. The server 400 verifies from CK¹ that this is the same user, and responds by sending to him the first form page for home insurance to fill in. At the same time, and together with the form, the server sends to the user an RT program 900 that monitors the user entries. The first page of the form is therefore immediately displayed on the user screen, and the RT program 900 is activated at the user browser 500. The RT program 900 continues by accessing the monitor server 700, which responds by sending to the user browser 500 all the rules or only the rules relevant to home insurance, together with cookie CK². As said, one of the rules, Rule 701, defines the scenario and action regarding home insurance of residents of New Orleans as described above. Having the rules, the RT program 900 saves them within CK², and uses them to monitor the user entries. If the home insurance forms span more than one page, the same RT program 900 is sent to the user browser 500 with each requested page and activated within the user browser 500. In any case, the RT program 900 monitors the user entries, and verifies whether any of the defined rules scenarios, as saved in CK² are met. If a scenario is met, and in this specific case, if the RT program 900 determines that the user who is filling home insurance forms resides in the New Orleans area, the action which corresponds to this rule is activated. The action may cause an access to the monitoring server 700 (together with CK² which stores the states which led to said action). However, the unique aspect of the invention is that the rule can be monitored and enforced in real-time at the browser side, thus preventing the necessity of completion of the application process. This allows for an early response to the specific matching customers only. In a more complex scenario, the rule may exclude specific customers, which requires careful analysis of customer values on corporate databases. In such a case, the action determined by the browser is to transmit the cookie to the monitoring server 700. The monitoring server 700 analyzes the cookie CK² that is transmitted to it from the browser 500, and verifies the more complex rules that may apply. Then, it can extract from its rule base 100 a message corresponding to said complex action stating “home insurance policies to most residents of New Orleans area are temporarily not available. As an exceptional customer we offer you a special offer . . . ”. This message is sent to the user browser, and displayed to the user as a new layer, for example in a “balloon” format.

In another alternative, the RT program 900 may also prevent the user from typing in the relevant fields a residence location in the New Orleans area. In another example, as soon as the user indicates that he is interested in a home insurance, the rule will be applied, to indicate to any new customer that home insurance is not available for residents of the New Orleans area during this week. This may happen even before the user has filled any additional information.

### EXAMPLE 2

In this case the marketing manager defines a rule for those applying for health insurance. If a scenario is determined that the user is married and has more than three children under the age of 18, the corresponding action should display to the user a message stating that the company now has a special offer for accident insurance. The process is performed in a similar manner as before, however, in this case the eligibility for this offer naturally involves accessing many additional systems which are internal to the corporate and require real-time evaluation during the interaction. In this case the message which is displayed to the user states “we now have a special offer for accidents policy—please press [link]”.

As shown in the description and examples above, the invention provides a web system in which the web user entries and form fields are monitored in real time. When a user predefined entry or a sequence of predefined entries match a predefined scenario, as stored within a cookie at the user terminal, an action is taken immediately. This action spans both the browser and the server environment. This is in contrast to prior art systems in which rules can be enforced only after completion of the forms, and submitting them to the server. It is also in contrast to the prior art where rules need to be hard-coded into the server. In such a manner, the corporate rules can be enforced within web business applications in compliance with the way that they are enforced within the in-house applications in a short, business-oriented cycle, rather than involving a programming cycle.

It should be noted that the system as described comprises two separate servers, the application server and the monitoring server. The inclusion of two separate servers, as described, was done for the sake of brevity. The functions of the system, as described, may be obtained in a similar manner by a single server, which includes the functions of said two separate servers.

In the description of the invention, reference was made to JavaScript and cookie-based implementation as a preferred implementation. Naturally, this is not the only possible way to gain this real-time rule enforcement. Recent developments in browser technology which uses Ajax for programming within the browser and XML as a media for data transfer between browser and server allow for easily implementing a similar system using these technologies.

Naturally, these are examples for programs executed within the browser, and data transfers to these programs. Other technologies such as ActivX and Flash allow for running programs within the browser, and data can be transferred also in other protocols to these applications.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. Method for enforcing corporate rules in real time at a user end within a business web application operated from the corporate site server, wherein said web application conveys to a user browser a form to fill in, and wherein said form includes one or more pages, each page comprises one or more fields for receiving user entries, the method comprising:
a. providing a monitoring server at the corporate side;
b. providing a corporate rule base accessible by said monitoring server, wherein each rule within the base comprises at least:
(i) a scenario definition, each scenario definition comprises at least one condition depending on a user behavior within a form; and
(ii) a predefined action to be activated in real-time when said scenario definition is met;
c. upon accessing the corporate server to receive a form, sending to a user terminal a first page of the form, including an RT monitoring program for monitoring the meeting of one or more rule scenarios at the user terminal and at least a reference to said monitoring server;
d. upon receipt of the form at the user side, activating said RT monitoring program at the user terminal including said reference, thereby to access said monitoring server;
e. upon accessing said monitoring server, sending by the monitoring server to said user terminal one or more rules from said rule base;
f. monitoring by said RT program the user behavior within at least one of the form pages; and
g. upon detection that a rule scenario is met, immediately activating the action which corresponds to said rule scenario.

2. Method according to claim 1, wherein said user behavior is at least one predefined user entry within at least one field within a form page.

3. Method according to claim 1, wherein said user behavior is a predefined navigation sequence into at least one predefined form page.

4. Method according to claim 2, wherein the scenario condition further includes specific data entries from the corporate database into form pages in response to one or more user entries.

5. Method according to claim 1, wherein said one or more rules are sent from the monitoring server to the user terminal within a cookie.

6. Method according to claim 1, wherein the one or more rules that are sent from the monitoring server to the user terminal are sent as an XML file.

7. Method according to claim 1, wherein said RT program is a Javascript, Ajax or ActiveX program.

8. Method according to claim 1, wherein the form comprises more than one page, and wherein with each access of the client to receive a form page, a copy of the RT program is also provided and activated at the client side.

9. Method according to claim 1, wherein said action involves an access to the monitoring server to receive an additional program which is activated at the client terminal.

10. Method according to claim 1, wherein the action includes initiation of at least one of the following:
a) displaying at the client terminal a predefined message;
b) preventing the insertion of specific data to a specific field of the form;
c) preventing the possibility of submitting the form; and
d) providing guidance to the user for an allowed field entry.

11. Method according to claim 1, wherein the business application is a CRM or ERP application.

12. Method according to claim 1, wherein the communication between the business application, the monitoring server and the user browser is stateless.

13. Method according to claim 1, wherein said rule base is a common corporate rule base wherein a portion of the rules within said rule base are used for enforcement only over in-house users, another portion is used for enforcement over only web users, and at least a portion of the rules is used for enforcement over both in-house users and web users.

14. Method according to claim 1, the rule definition further comprises at least one milestone, in which a communication is made to the corporate server for receiving corresponding data in response to reaching said milestone.
